(19) United States
(12) Patent Application Publication
(10) Pub. No.: US 2026/0362149 A1
(43) Pub. Date: Nov. 12, 2026

(54) ENHANCED COORDINATED SPATIAL REUSE TRANSMISSION TO SUPPORT LOW LATENCY DATA

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/486,761

(22) PCT Filed: Jun. 28, 2024
(86) PCT No.: PCT/US2024/036183

§ 371 Date: Nov. 21, 2025

Related U.S. Application Data
(60) Provisional application No. 63/512,036, filed on Jul. 5, 2023.

(51) Int. Cl. H04W 16/02

(52) U.S. Cl. CPC H04W 16/02

(57) ABSTRACT

A new enhanced Multi-User (MU) Request-to-Send (RTS) Transmit Opportunity Sharing (TXS) frame and solutions for handling unavailable resource units (RUS) at a shared access point (AP) side. A sharing AP can allocate a portion of its RUs and TXOP to shared APs, facilitating C-TDMA coordination and reducing resource waste. The disclosed solutions focus on efficiently handling unavailable RUs at the shared AP side during the allocated TXOP sharing time. When a shared AP cannot fully utilize the allocated RUs due to interference, it can return the interfered RUs to the sharing AP or assign them to another shared AP. By dynamically managing and reallocating interfered RUs, the disclosed solutions optimize resource utilization, minimize waste, and increase overall system throughput in high-density wireless networks.

### CROSS-REFERENCE TO RELATED APPLICATION

This application claims the benefit of U.S. Provisional Application No. 63/512,036 filed Jul. 5, 2023, the entire contents of which is hereby incorporated by reference.

### TECHNICAL FIELD

The present disclosure generally relates to wireless communications, and more specifically, relates to enhanced coordinated spatial reuse transmission to support low latency data in Institute of Electrical and Electronics Engineers (IEEE) 802.11 standards.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHZ, and 60 GHz bands. These standards define the protocols that enable Wi-Fi devices to communicate with each other. The 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) Orthogonal Frequency Division Multiple Access (OFDMA) transmission where multiple frames are transmitted to or from multiple stations (STAs) simultaneously using different frequency resources, in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 illustrates an example of Code-Division Time-Division Multiple Access (C-TDMA) operation in an Overlapping Basic Service Set (OBSS) network, in accordance with some embodiments of the present disclosure.

FIG. 11 illustrates an example of enhanced Coordinated-Spatial Reuse (C-SR) operation in an Overlapping Basic Service Set (OBSS) network where Low Latency (LL) data is transmitted by an access point, in accordance with some embodiments of the present disclosure.

FIG. 12 illustrates an example of enhanced Coordinated-Spatial Reuse (C-SR) in a Code-Division Time-Division Multiple Access (C-TDMA) scenario where Low Latency (LL) data is transmitted by a sharing access point, in accordance with some embodiments of the present disclosure.

FIG. 13 illustrates an example of enhanced Coordinated-Spatial Reuse (C-SR) in a Code-Division Time-Division Multiple Access (C-TDMA) scenario where Low Latency (LL) data is transmitted by a station, in accordance with some embodiments of the present disclosure.

FIG. 14 is a flowchart of a method for enhanced coordinated spatial reuse transmission to support low latency data performed by an Access Point (AP) in a Basic Service Set (BSS), in accordance with some embodiments of the present disclosure.

FIG. 15 is a flowchart of a method for enhanced coordinated spatial reuse transmission to support low latency data performed by an Access Point (AP) in a Basic Service Set (BSS), in accordance with some embodiments of the present disclosure.

FIG. 16 is a flowchart of a method for enhanced coordinated spatial reuse transmission to support low latency data performed by a shared Access Point (AP) in a Basic Service Set (BSS), in accordance with some embodiments of the present disclosure.

### DETAILED DESCRIPTION

The present disclosure generally relates to wireless communications, and more specifically, relates to enhanced coordinated spatial reuse transmission to support low latency data in Institute of Electrical and Electronics Engineers (IEEE) 802.11 standards including beyond IEEE 802.11be.

### Overview

The IEEE 802.11be standard, which is an extension of the current IEEE 802.11 standard, encompasses various coordination schemes for multiple access points (APs). These schemes include Coordinated-Time Division Multiple Access (C-TDMA), Coordinated-Orthogonal Frequency Division Multiple Access (C-OFDMA), and Coordinated Spatial Reuse (C-SR).

In the existing IEEE 802.11 standard, when APs engage in C-TDMA, the transmit opportunity (TXOP) holder AP, also known as the sharing AP, shares its TXOP with another AP, referred to as the shared AP, for a specific duration. Once the shared AP obtains the TXOP from the TXOP holder AP, it gains the right to access the channel, allowing it to transmit buffered Protocol Data Units (PPDUs) or request PPDUs from associated stations (STAs).

However, a problem arises when event-based, non-deterministic Low Latency (LL) data occurs on the TXOP holder AP's side during the allocated time for the shared AP. In such cases, the sharing AP is required to defer its low latency traffic until the end of the shared AP's allocated duration. To address this issue, the present disclosure introduces an enhanced C-SR methodology that enables the transmission of LL data during the shared AP's allocated time in C-TDMA.

The enhanced C-SR methodology addresses issue of transmitting Low Latency (LL) data without significant delay or latency when LL data traffic arises at the transmit opportunity (TXOP) holder access point (AP) during the shared AP's allocated time in Coordinated-Time Division Multiple Access (C-TDMA). In an embodiment of the enhanced C-SR methodology, the LL data is transmitted within the shared AP's allocated time using constrained transmit power through an enhanced Coordinated Spatial Reuse (C-SR) technique. This approach is particularly beneficial in scenarios where multiple Basic Service Sets (BSSs) are coordinated or overlapped. In such situations, the transmissions can coexist without causing harmful interference to one another, ultimately leading to increased spectral efficiency.

An embodiment addresses the problem of transmitting low latency data without significant delay when, for example, such data arises at the transmit opportunity (TXOP) holder access point (AP) during the shared AP's allocated time in Coordinated-Time Division Multiple Access (C-TDMA). According to the embodiment, a method is performed by a wireless device operating as a first access point in a first basic service set.

The first access point generates a trigger frame to solicit the transmission of a trigger-based physical protocol data unit (TB PPDU) from a station within its basic service set. The trigger frame includes a parameterized spatial reuse input parameter value, which is intended for use by a second access point in a second basic service set that overlaps with the first basic service set. This parameter value helps the second access point determine the appropriate transmit power for transmitting low latency data under an enhanced coordinated spatial reuse condition.

By including the parameterized spatial reuse input parameter value in the trigger frame, the first access point enables the second access point to transmit low latency data within the shared AP's allocated time using constrained transmit power through the enhanced Coordinated Spatial Reuse (C-SR) technique. This approach allows transmissions from both access points to coexist without causing harmful interference to one another, resulting in increased spectral efficiency, particularly in scenarios where multiple Basic Service Sets (BSSs) are coordinated or overlapped.

After generating the trigger frame with the parameterized spatial reuse input parameter value, the first access point wirelessly transmits the trigger frame to solicit the transmission of the TB PPDU from the station in its basic service set.

The method of the embodiment enhances the coordination between access points in overlapping basic service sets, enabling the efficient transmission of low latency data during shared time allocations in C-TDMA by utilizing an enhanced C-SR technique with constrained transmit power.

Another embodiment addresses the problem of transmitting low latency data without significant delay when, for example, such data arises at the transmit opportunity (TXOP) holder access point (AP) during the shared AP's allocated time in Coordinated-Time Division Multiple Access (C-TDMA). According to this embodiment, a method is performed by a wireless device operating as a first access point in a first basic service set.

The first access point receives a trigger frame sent by a second access point in a second basic service set that overlaps with the first basic service set. The second access point sends this trigger frame to solicit the transmission of a trigger-based physical protocol data unit (TB PPDU) from a station within its basic service set. The received trigger frame includes a parameterized spatial reuse input parameter value intended for use by the first access point. This parameter value helps the first access point determine the appropriate transmit power for transmitting low latency data under an enhanced coordinated spatial reuse condition.

Upon receiving the trigger frame, the first access point determines the particular transmit power for transmitting low latency data under the enhanced coordinated spatial reuse condition based on the parameterized spatial reuse input parameter value provided in the trigger frame.

Having determined the appropriate transmit power, the first access point wirelessly transmits the low latency data at the determined transmit power under the enhanced coordinated spatial reuse condition. This approach allows the first access point to transmit low latency data within the shared AP's allocated time using constrained transmit power through the enhanced Coordinated Spatial Reuse (C-SR) technique, enabling transmissions from both access points to coexist without causing harmful interference to one another, resulting in increased spectral efficiency.

The method of this other embodiment enables the efficient transmission of low latency data by a first access point during shared time allocations in C-TDMA by utilizing an enhanced C-SR technique with constrained transmit power, which is determined based on the parameterized spatial reuse input parameter value received from a second access point in an overlapping basic service set.

Still yet another embodiment addresses the problem of transmitting low latency data without significant delay when such data arises at the transmit opportunity (TXOP) holder access point (AP) during the shared AP's allocated time in Coordinated-Time Division Multiple Access (C-TDMA). According to this embodiment, a method is performed by a wireless device operating as a shared access point in a first basic service set.

The shared access point generates a trigger frame to solicit the transmission of a trigger-based physical protocol data unit (TB PPDU) from a station within its basic service set. The trigger frame includes a parameterized spatial reuse input parameter value, which is intended for use by a wireless device in a second basic service set that overlaps with the first basic service set. This parameter value helps the wireless device in the second basic service set determine the appropriate transmit power for transmitting low latency data under an enhanced coordinated spatial reuse condition.

By including the parameterized spatial reuse input parameter value in the trigger frame, the shared access point enables the wireless device in the second basic service set to transmit low latency data within the shared AP's allocated time using constrained transmit power through the enhanced Coordinated Spatial Reuse (C-SR) technique. This approach allows transmissions from both the shared access point and the wireless device in the overlapping basic service set to coexist without causing harmful interference to one another, resulting in increased spectral efficiency.

After generating the trigger frame with the parameterized spatial reuse input parameter value, the shared access point wirelessly transmits the trigger frame to solicit the transmission of the TB PPDU from the station in its basic service set.

The method of this embodiment enhances the coordination between the shared access point and wireless devices in overlapping basic service sets, enabling the efficient transmission of low latency data during the shared access point's allocated time in C-TDMA by utilizing an enhanced C-SR technique with constrained transmit power.

Embodiments also encompass a wireless device comprising a radio frequency transceiver, a memory device, a set of one or more processors coupled to the memory device, and a set of instructions stored in the memory device and configured to cause the wireless device to perform any of the foregoing methods.

### Wireless Communications

In this detailed description, only certain embodiments are shown and described, simply by way of illustration. As those skilled in the art would realize, the described embodiments may be modified in various ways, all without departing from the spirit or scope of the present disclosure. Accordingly, the drawings and description are to be regarded as illustrative in nature and not restrictive. Like reference numerals designate like elements throughout the specification.

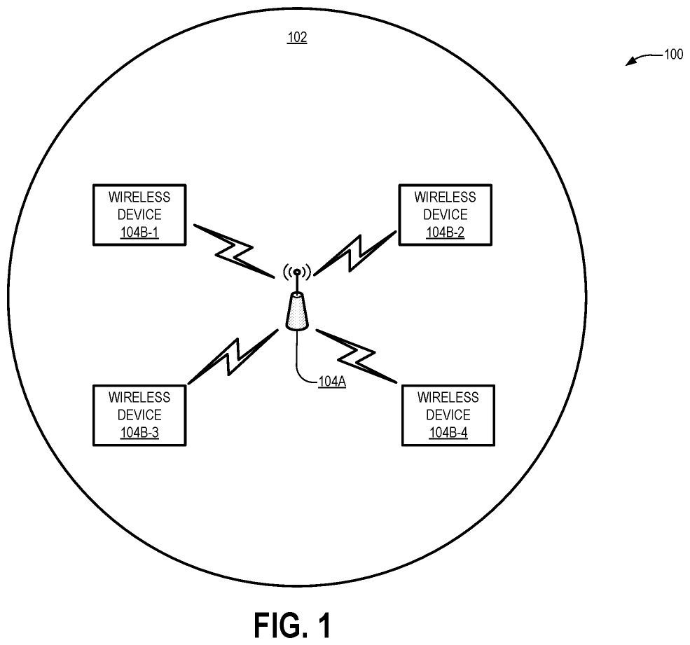

Turning now to FIG. 1, it illustrates example wireless local area network (WLAN) 100. WLAN 100 encompasses example basic service set (BSS) 102. BSS 102 is composed of multiple WLAN devices 104. Each WLAN device 104 within BSS 102 is equipped with a medium access control (MAC) layer and a physical (PHY) layer, which adhere to one or more IEEE (Institute of Electrical and Electronics Engineers) 802.11 standards.

Among WLAN devices 104 in BSS 102, at least one device serves as an access point (AP) station 104A, while the remaining devices function as non-AP stations (non-AP STAs) 104B. In an ad-hoc networking environment, all WLAN devices 104 may be non-AP STAs. Generally, both the AP STA and the non-AP STAs can be referred to individually as a STA or collectively as STAs. However, for the sake of providing clear examples in this description, only the non-AP STAs are referred to as STAs.

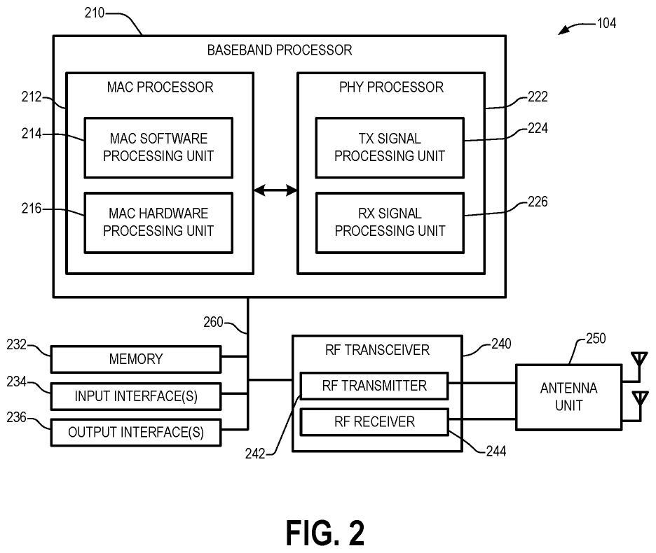

FIG. 2 is a schematic block diagram that represents a WLAN device, labeled as WLAN device 104, which comprises several components. Baseband processor 210 is responsible for performing baseband signal processing and includes two sub-components: MAC processor 212 and PHY processor 222. MAC processor 212 may be further divided into MAC software processing unit 214 and MAC hardware processing unit 216. Memory 232, which can be a non-transitory computer-readable medium, stores MAC software that implements some functions of the MAC layer. MAC software processing unit 214 executes this software, while MAC hardware processing unit 216 implements the remaining MAC layer functions in hardware.

PHY processor 222 comprises transmitting (TX) signal processing unit 224 and receiving (RX) signal processing unit 226, which handle the physical layer processing of the transmitted and received signals, respectively.

Other components of WLAN device 104 include RF transceiver 240, which facilitates wireless communication, antenna unit 250 for transmitting and receiving signals, input interface unit 234 for receiving user input, and output interface unit 236 for providing output to the user. All these components, along with baseband processor 210 and memory 232, communicate with each other through bus 260, which serves as a communication pathway within the device.

RF transceiver 240 is a component of WLAN device 104 that encompasses two sub-components: RF transmitter 242 and RF receiver 244. These sub-components are responsible for transmitting and receiving RF signals, respectively.

In addition to storing the MAC software, memory 232 may also store an operating system and various applications necessary for the functioning of the WLAN device.

Input interface unit 234 is responsible for receiving information from the user, such as commands or data input. On the other hand, the output interface unit 236 is tasked with outputting information to the user, which could include status updates, processed data, or any other relevant information.

Antenna unit 250 comprises one or more antennas that facilitate wireless communication between the WLAN device and other devices in the network. In cases where a multiple-input multiple-output (MIMO) or a multiuser MIMO (MU-MIMO) system is employed, antenna unit 250 may include multiple antennas to support these advanced communication techniques, which enhance the capacity and performance of the wireless network.

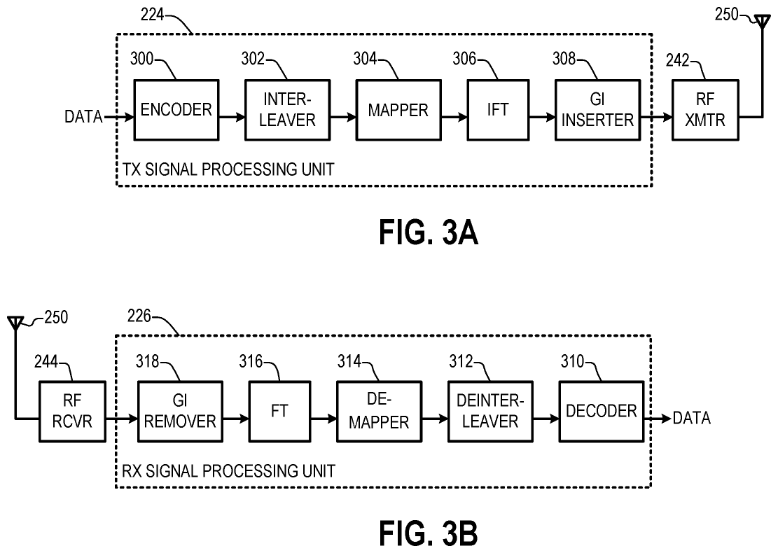

FIG. 3A illustrates transmitting signal processing unit 224 in WLAN device 104. Unit 224 encompasses several components that process the input data before transmission. Encoder 300 encodes the input data using forward error correction (FEC) techniques, such as binary convolutional code (BCC) or low-density parity-check (LDPC) encoding. A scrambler may be used to scramble the input data before encoding to reduce the occurrence of long sequences of 0s or 1s. If BCC encoding is used, an encoder parser may be employed to demultiplex the scrambled bits among multiple BCC encoders.

Interleaver 302 changes the order of bits in each stream output from the encoder, which is applicable only when BCC encoding is used. Mapper 304 then maps the interleaved bits to constellation points. If LDPC encoding is used, mapper 304 may also perform LDPC tone mapping.

When MIMO or MU-MIMO is used, multiple interleavers 302 and mappers 304 may be employed, corresponding to the number of spatial streams (NSS). A stream parser divides the outputs of the BCC encoders or the LDPC encoder into blocks sent to different interleavers 302 or mappers 304. A space-time block code (STBC) encoder spreads the constellation points from the spatial streams into space-time streams, and a spatial mapper maps the space-time streams to transmit chains using direct mapping, spatial expansion, or beamforming.

Inverse Fourier transformer (IFT) 306 converts the constellation points from the mapper or spatial mapper to a time-domain symbol using an inverse discrete Fourier transform (IDFT) or an inverse fast Fourier transform (IFFT). When MIMO or MU-MIMO is used, cyclic shift diversities (CSDs) may be inserted to prevent unintentional beamforming, either before or after the IFT, per transmit chain, per space-time stream, or as part of the spatial mapper.

Guard interval (GI) inserter 308 prepends a GI to each symbol, and optional windowing may be applied to smooth the symbol edges. Finally, RF transmitter 242 converts the symbols into an RF signal and transmits it via antenna unit 250. In MIMO or MU-MIMO systems, the GI inserter and RF transmitter may be provided for each transmit chain.

As illustrated in FIG. 3B, receiving signal processing unit 226 in WLAN device 104 encompasses several components that process the received RF signal. RF receiver 244 receives the RF signal via antenna unit 250 and converts it into one or more symbols. Guard interval (GI) remover 318 removes the GI from the symbol. In MIMO or MU-MIMO systems, RF receiver 244 and GI remover 318 may be provided for each receive chain.

Fourier transformer (FT) 316 converts the time-domain symbol into a block of constellation points using a discrete Fourier transform (DFT) or a fast Fourier transform (FFT). In MIMO or MU-MIMO systems, a spatial demapper may be used to convert the Fourier transformed receiver chains to constellation points of the space-time streams, and an STBC decoder may despread the constellation points from the space-time streams into the spatial streams.

Demapper 314 demaps the constellation points from FT 316 or STBC decoder to bit streams. If LDPC encoding is used, the demapper may also perform LDPC tone demapping before constellation demapping. Deinterleaver 312 deinterleaves the bits of each stream from the demapper, which is applicable only when BCC encoding is used.

In MIMO or MU-MIMO systems, multiple demappers 314 and deinterleavers 312 may be used, corresponding to the number of spatial streams. A stream deparser may be employed to combine the streams from the deinterleavers.

Decoder 310 decodes the streams from deinterleaver 312 or stream deparser. The decoder may be an FEC decoder, such as a BCC decoder or an LDPC decoder. A descrambler may be used to descramble the decoded data. If BCC decoding is used, an encoder deparser may multiplex the data decoded by multiple BCC decoders. If LDPC decoding is used, the encoder deparser may not be necessary.

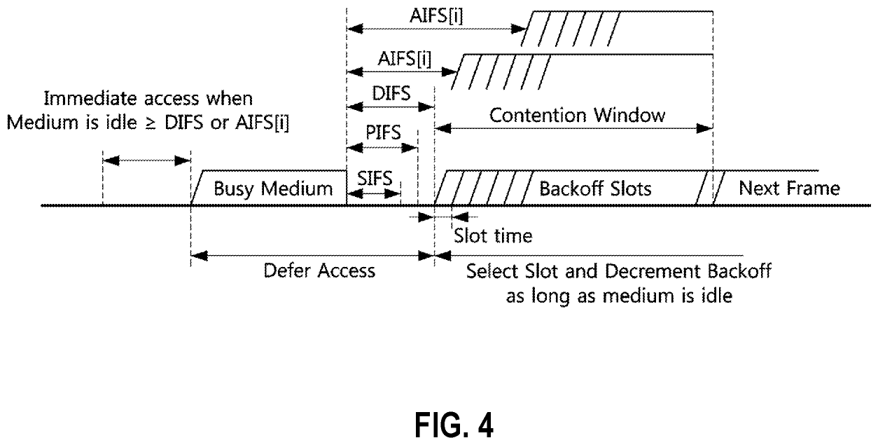

FIG. 4 illustrates the relationships between different types of interframe spaces (IFS) in a WLAN system. WLAN devices can exchange data frames, control frames, or management frames. Data frames are used to transmit data to higher layers, and a WLAN device transmits a data frame after performing backoff if a distributed coordination function IFS (DIFS) has elapsed from the time the medium has been idle.

Management frames are used to exchange management information that is not forwarded to higher layers. Subtype frames of management frames include beacon frames, association request/response frames, probe request/response frames, and authentication request/response frames. Control frames are used to control access to the medium and include subtypes such as request-to-send (RTS) frames, clear-to-send (CTS) frames, and acknowledgement (ACK) frames.

If a control frame is not a response frame to a previous frame, the WLAN device transmits the control frame after performing backoff if the DIFS has elapsed. However, if the control frame is a response frame to a previous frame, the WLAN device transmits the control frame without performing backoff if a short IFS (SIFS) has elapsed. The type and subtype of a frame can be identified by the type field and subtype field in the frame control field.

Quality of Service (QoS) stations (STAs) may transmit frames after performing backoff if an arbitration IFS (AIFS) for an associated access category (AC) (e.g., AIFS[AC]) has elapsed. In this case, data frames, management frames, or control frames that are not response frames may use the AIFS[AC].

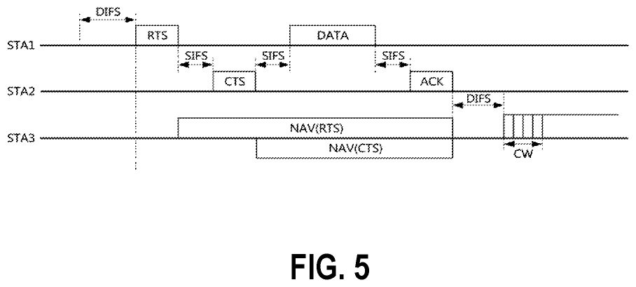

FIG. 5 illustrates a CSMA/CA-based frame transmission procedure for avoiding collisions between frames in a channel. In this scenario, STA1 is the transmit WLAN device, STA2 is the receive WLAN device, and STA3 is a WLAN device located in an area where it can receive frames transmitted from both STA1 and STA2.

STA1 determines channel availability by carrier sensing, which can be based on the energy level on the channel, correlation of signals in the channel, or by using a network allocation vector (NAV) timer. After determining that the channel is idle for a duration of DIFS, STA1 transmits an RTS frame to STA2 after performing backoff. Upon receiving the RTS frame, STA2 responds with a CTS frame after SIFS.

When STA3 receives the RTS frame, it sets its NAV timer for the transmission duration of subsequent frames using the duration information included in the RTS frame. This duration may include SIFS+CTS frame duration+SIFS+data frame duration+SIFS+ACK frame duration. Similarly, when STA3 receives the CTS frame, it sets its NAV timer for the transmission duration of subsequent frames using the duration information included in the CTS frame. If STA3 receives a new frame before the NAV timer expires, it updates the NAV timer using the duration information in the new frame. STA3 does not attempt to access the channel until the NAV timer expires.

After receiving the CTS frame from STA2, STA1 transmits a data frame to STA2 after SIFS elapses from the time the CTS frame was completely received. Upon successfully receiving the data frame, STA2 responds with an ACK frame after SIFS elapses.

When the NAV timer expires, STA3 determines if the channel is busy using carrier sensing techniques. If the channel is not in use by other devices during DIFS and after the NAV timer has expired, STA3 may attempt channel access after a random backoff within a contention window has elapsed.

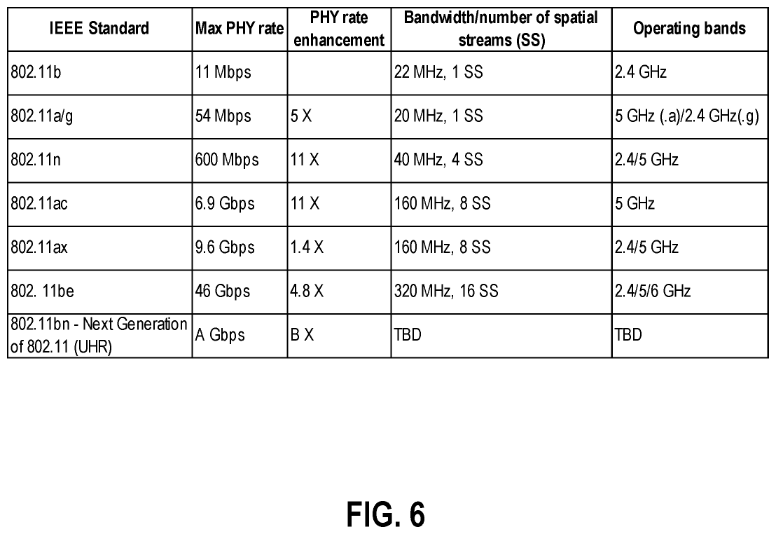

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR.

IEEE 802.11be focuses on WLAN indoor and outdoor operation in the 2.4, 5, and 6 GHz frequency bands, with various candidate features being considered, such as 320 MHz bandwidth, enhanced multi-band/multi-channel aggregation, 16 spatial streams, enhanced multi-AP coordination, and enhanced link adaptation and retransmission protocols.

The focus of IEEE 802.11bn (UHR) is still under discussion, with candidate features including MLO enhancements, latency and reliability improvements, bandwidth expansion, aggregated PPDU, enhanced multi-link single-radio extensions to AP, roaming improvements, and power-saving schemes.

Some of these features, such as increasing bandwidth and the number of spatial streams, have proven effective in previous projects aimed at increasing link throughput and are considered feasible.

With the availability of the wide 6 GHz unlicensed band (5.925-7.125 GHZ), Wi-Fi devices can access wider bandwidths, enabling larger than 160 MHz data transmissions (e.g., 320 MHz/640 MHz) to increase the maximum PHY rate. This can be achieved by transmitting data in the 6 GHz band or across both the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

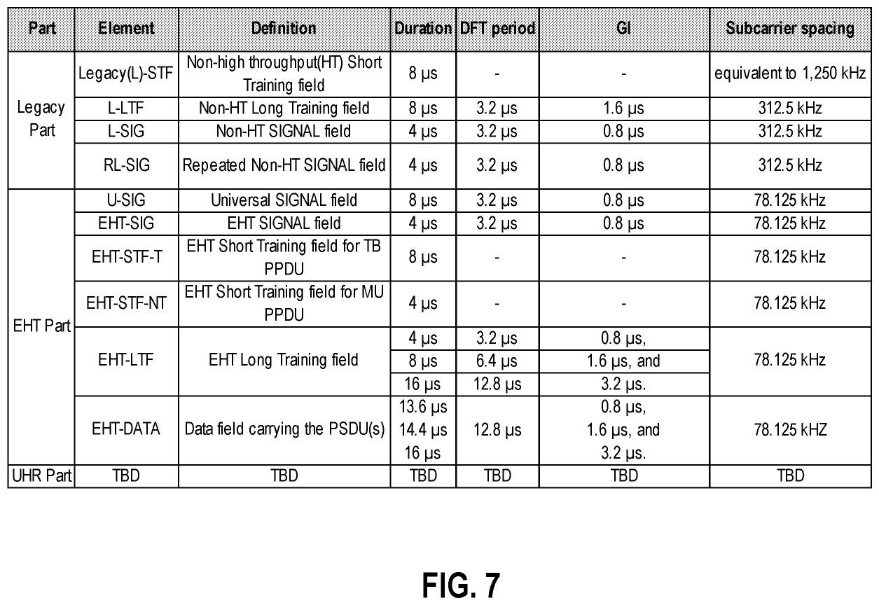

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

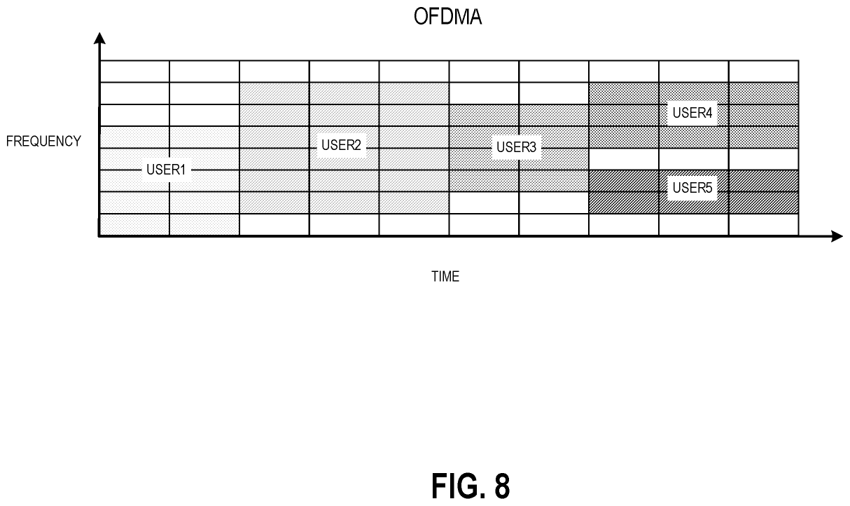

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission (e.g., as depicted in FIG. 8) and different spatial streams in Multi-User Multiple Input Multiple Output (MU-MIMO) transmission.

Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

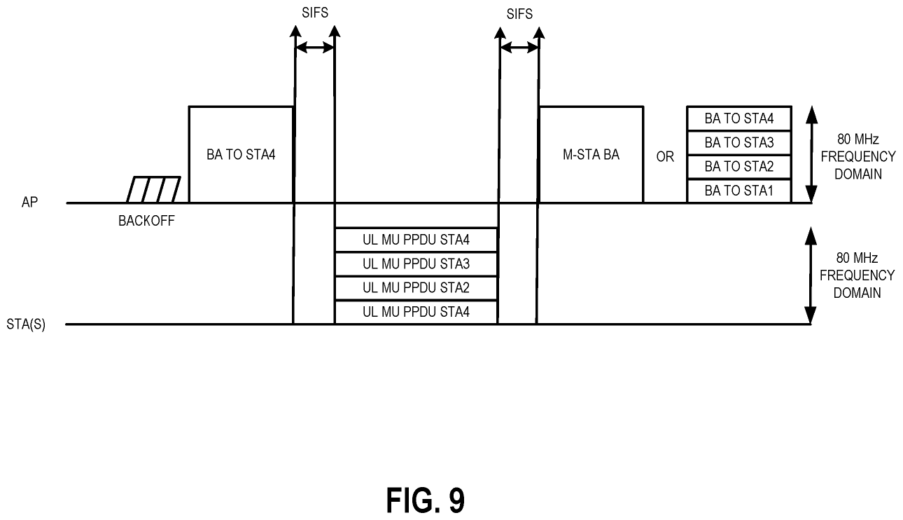

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

WLAN systems rely on the retransmission of MAC Protocol Data Units (MPDUs) when the transmitter (TX) does not receive an acknowledgement from the receiver (RX) or when the MPDUs are not successfully decoded at the RX. In the traditional Automatic Repeat Request (ARQ) approach, the receiver discards the last failed MPDU before receiving the new retransmitted one. To meet the requirements of enhanced reliability and reduced latency, the 11be working group decided to evolve this approach toward Hybrid ARQ (HARQ).

HARQ processing can be done using two methods: Type 1 HARQ, also known as Chase Combining (CC), and Type 2 HARQ, also known as Incremental Redundancy (IR).

In Type 1 HARQ (CC), the retransmitted signals are the same as the previously failed signal because all retransmitted subpackets use the same puncturing pattern. Puncturing removes some parity bits after encoding with an error-correction code. Using the same puncturing pattern in CC-HARQ generates a coded data sequence with forward error correction (FEC) and enables the receiver to use maximum-ratio combining (MRC) to combine the received bits with the same bits from previous transmissions. In WLAN systems, one HARQ packet is divided into four subpackets. The information sequences are usually transmitted in fixed-length packets, and error correction and detection are performed on the entire packet at the receiver. If the packet is found to be in error, the conventional ARQ scheme is inefficient when burst errors occur. Applying subpackets can improve this situation more efficiently, as only the subpackets containing errors need to be retransmitted.

The receiver uses both the current and previously received subpackets to decode the packet, reducing the error probability as more subpackets are used. The decoding process passes the CRC check and ends when the packet is decoded without error or when the maximum number of subpackets is reached. Because HARQ operates in a stop-and-wait protocol, the terminal sends an ACK to the transmitter if it can decode the packet, and the transmitter terminates the HARQ transmission upon receiving the ACK correctly. If the terminal cannot decode the packet, it sends a NAK to the transmitter, triggering the retransmission process.

In Type 2 HARQ (IR), different puncturing patterns are used for each subpacket, causing the signal to change for each subpacket. IR uses two puncturing patterns alternately for odd-numbered and even-numbered transmissions, resulting in a coded data sequence with the coding rate used in IR HARQ. The redundancy scheme of IR improves the Log Likelihood Ratio (LLR) of the parity bit by combining information sent across different transmissions and lowers the code rate as additional subpackets are used, leading to a lower error rate compared to CC. The puncturing pattern used in HARQ is indicated by the Subpacket Identity (SPID). The first subpacket's SPID is always set to 0, and it contains all the systematic bits and punctured parity bits, allowing self-decoding when the receiving SNR environment is good. Generally, subpacket SPIDs are transmitted in increasing order but can be exchanged, except for the first SPID.

### Enhanced Coordinated Spatial Reuse Tranmission To Support Low Latency Data

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:
Coordinated Beamforming (C-BF): Multiple APs transmit on the same frequency resource by coordinating and forming spatial nulls, allowing for simultaneous transmission from multiple APs.
Coordinated OFDMA (C-OFDMA): APs transmit on orthogonal frequency resources by coordinating and splitting the spectrum, enabling more efficient spectrum utilization.
Joint Transmission (JTX): Multiple APs transmit jointly to a given user simultaneously by sharing data between the APs.
Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Multi-access point (M-AP) coordination technology is a useful candidate feature in the IEEE 802.11 standards, including 802.11be and future Wi-Fi standards like 802.11bn. Various M-AP technologies, such as Coordinated TDMA (C-TDMA), Coordinated OFDMA (C-OFDMA), and Coordinated Spatial Reuse (C-SR), are being considered. These technologies aim to increase spectral efficiency and facilitate the transmission of Low Latency (LL) data in dense networks.

In the case of C-TDMA, the TXOP holder AP (sharing AP) can share its transmit opportunity (TXOP) with a shared AP. During the shared TXOP duration, the shared AP can transmit its PPDUs or solicit PPDUs to associated STAs. If LL data occurs at the shared AP's side during the obtained TXOP duration, it can be transmitted efficiently. However, due to the non-deterministic and event-based nature of LL data, it may occur at the sharing AP's side when all TXOP periods have been completely handed over to the shared AP.

According to the current TXOP management rule, non-TXOP holder devices are not allowed to transmit data during other devices' TXOP durations. This means that LL data occurring at the sharing AP's side cannot be transmitted during the shared AP's TXOP duration in the C-TDMA manner. To address this issue, the present disclosure proposes an enhanced C-SR scheme that enables the transmission of LL data at the sharing AP's side without collision or with minimal interference during the shared AP's TXOP duration. This enhancement aims to improve the efficiency and responsiveness of LL data transmission in M-AP coordination scenarios.

In the current state of Coordinated Spatial Reuse (C-SR) transmissions, two modes are being explored: Overlapping BSS (OBSS) packet detection and Parameterized SR (PSR) based. In the OBSS/PD mode, the clear channel assessment (CCA) threshold is dynamically adjusted to ignore frames from other BSSs (inter-BSS frames). This allows devices to transmit even when there is ongoing communication in neighboring BSSs, as long as the signal strength of the inter-BSS frames is below the adjusted CCA threshold.

In the PSR mode, stations (STAs) control their transmit power to minimize interference with the transmissions of devices in overlapping BSSs. By reducing the transmit power, STAs can limit the impact of their transmissions on nearby devices, allowing for more efficient spatial reuse.

The present disclosure proposes an enhanced C-SR transmission method that is specifically designed for Coordinated TDMA (C-TDMA) situations. This enhanced C-SR transmission aims to support low latency (LL) data occurring at the sharing AP's side. In C-TDMA, the sharing AP shares its transmit opportunity (TXOP) with a shared AP. However, if LL data arrives at the sharing AP during the shared TXOP, it cannot be transmitted immediately due to the current TXOP management rules. The proposed enhanced C-SR transmission method seeks to address this issue by allowing the sharing AP to transmit LL data during the shared TXOP without causing significant interference to the shared AP's transmissions.

FIG. 9 illustrates an example of Coordinated TDMA (C-TDMA) in an Overlapping BSS (OBSS) network, where two BSSs, BSS1 (AP1, STA11) and BSS2 (AP2, STA21, STA22), are overlapped. The sharing AP (AP1) and shared AP (AP2) that participate in C-TDMA are predefined using a beacon frame, management frame, or other means. To initiate C-TDMA, an enhanced MU-RTS TXS frame is introduced, which includes functions or entities for TXOP sharing between APs. In this scenario, AP1 shares its own TXOP with AP2 using the enhanced MU-RTS TXS frame. It is assumed that the STAs associated with the shared AP (AP2) may not set the basic Network Allocation Vector (NAV) when they overhear an enhanced MU-RTS TXS frame (an inter-BSS frame) from the sharing AP (AP1).

The present disclosure aims to address the issue of transmitting randomly occurring low latency (LL) traffic without significant delays in an IEEE 802.11 network. In the example shown in FIG. 9, LL traffic may occur at API's side when it has completed transferring its TXOP to the shared AP (AP2). However, due to the TXOP being handed over from AP1 to AP2 in the C-TDMA scenario, AP1 is not allowed to transmit LL traffic until the end of AP2's TXOP duration. To overcome this limitation, the present disclosure proposes an enhanced Coordinated Spatial Reuse (C-SR) method that utilizes a trigger frame, as depicted in the example of FIG. 9. This enhanced C-SR method enables AP1 to transmit LL data traffic even though it doesn't have channel access rights during AP2's TXOP. By employing this technique, the delay in transmitting LL traffic is reduced or minimized, thereby improving the overall performance and responsiveness of the network.

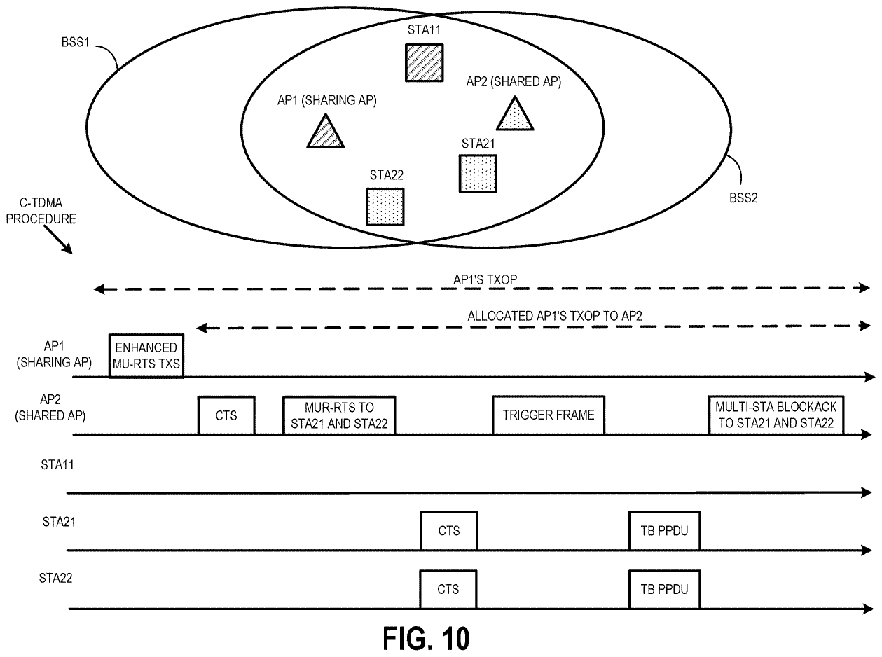

FIG. 10 illustrates an example of Parameterized Spatial Reuse (PSR) based enhanced Coordinated Spatial Reuse (C-SR) operation when low latency (LL) traffic occurs at the AP2 side in an Overlapping BSS (OBSS) network. In this scenario, two BSSs, BSS1 (AP1, STA11) and BSS2 (AP2, STA21, STA22), are overlapped. The conventional operation without enhanced C-SR involves STA11 transmitting its Trigger-Based (TB) PPDU (uplink) to AP1 after receiving a trigger frame (TF) from AP1, and AP1 sending back an ACK frame. In this case, AP2 sets the inter-BSS Network Allocation Vector (NAV) (e.g., basic NAV) to protect the TB PPDU from the triggered STA (STA11).

However, in the enhanced C-SR scenario, it is assumed that AP2 identifies an enhanced C-SR opportunity and may choose not to perform NAV update operations (e.g., NAV timer). Instead, AP2 can establish links to transmit LL data using the PSR mechanism depicted in FIG. 10. The steps of the PSR mechanism are depicted in the example of FIG. 10 with numbered circles.

At step 1, the process begins with AP1 transmitting a TF to STA11 to solicit a TB PPDU. The TF includes a PSR_INPUT parameter, which is calculated using the following Equation 1

PSR_INPUT=TX_PWR_AP+Acceptable Receiver Interference Level_AP Equation 1

The PSR_INPUT parameter depends on the total power used by AP1 to transmit the TF (TX_PWR_AP) and the maximum interference level that can be perceived by AP1 (Acceptable Receiver Interference Level_AP). Both the TX_PWR_AP and Acceptable Receiver Interference Level AP can be specified in Equation 1 in decibel-milliwatts (dBm).

At step 2, AP2 can overhear the TF from AP1 and identify an enhanced C-SR opportunity. If the enhanced C-SR condition valid duration triggered by AP1 is long enough, meaning that the duration field in the TF is sufficient to cover the frame exchanges required to support AP2's LL data (e.g., ‘LL data’+‘SIFS or PIFS’+‘ACK’+‘@’), AP2 can transmit LL data that occurs after receiving the TF from AP1. This means that AP2 can seize the enhanced C-SR opportunity during the enhanced C-SR condition valid period, as shown in the example of FIG. 10. The duration field in the TF sent by AP1 may be calculated as the sum of (‘Trigger frame’+‘SIFS’+‘UL TB PPDU’+‘ACK’+‘@’) length. When AP2 overhears that TF, it can identify the duration field and determine if the duration is sufficient to support its LL data transmission. In these examples the ‘@’ symbol is used to represent any time margin or buffer added to the duration calculation to account for potential delays, various, or uncertainties in the timing of frame exchanges.

When AP2 transmits LL data to STA21 during the C-SR condition valid period, it must control its transmit power using the enhanced C-SR value indicated in the TF from AP1. The transmit power of AP2 is calculated using the following Equation 2:

Transmit power_AP2−10*log(TX_BW_AP2/20 MHZ)<=PSR_INPUT-RPL Equation 2

Equation 2 takes into account the intended transmission bandwidth (TX_BW_AP2) and the received power level (RPL) of the TF. The parameter TX_BW_AP2 can be specified in Equation 2 in megahertz (MHz). And the RPL parameter can be specified in Equation 2 as decibel-milliwatts (dBm).

By employing this power control mechanism, AP2 can transmit LL data without incurring large delays and without interrupting the TB PPDU transmission from STA11 to AP1. This enhanced C-SR operation enables efficient transmission of LL traffic in OBSS networks while minimizing interference between overlapping BSSs.

The enhanced Coordinated Spatial Reuse (C-SR) scheme, an example of which is depicted in FIG. 10, can be expanded to the Coordinated Time Division Multiple Access (C-TDMA) scenario. In this scenario, when low latency (LL) data traffic arrives at AP1 after it has handed over its Transmit Opportunity (TXOP) to AP2, the LL data can be transmitted without significant delay by leveraging the expanded and enhanced C-SR mechanism.

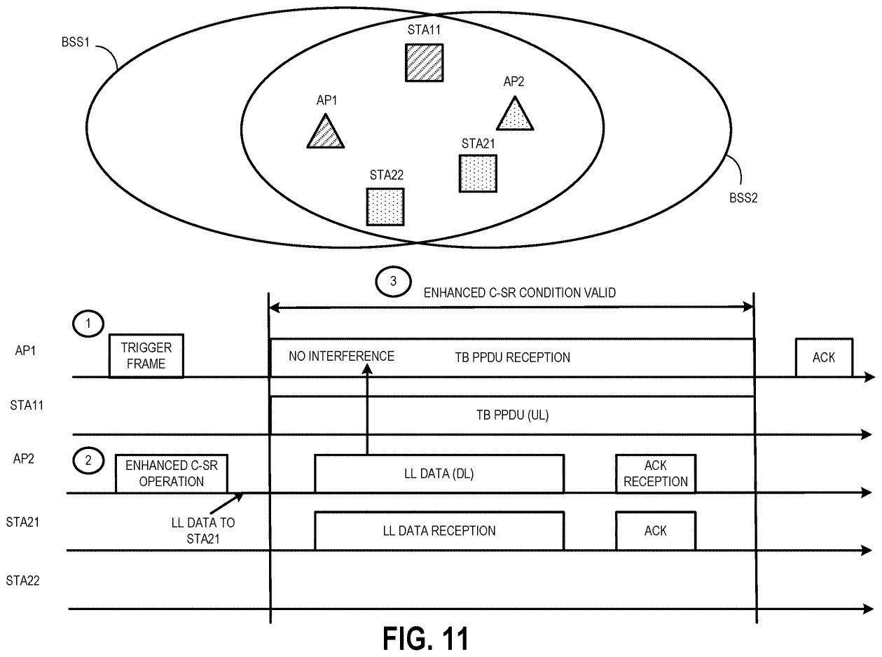

FIG. 11 illustrates a situation where AP1 and AP2 are associated for C-TDMA, and AP1 shares its TXOP with AP2. During AP2's TXOP duration, AP2 sends a Trigger Frame (TF) to STA21 and STA22 to solicit Trigger-Based (TB) PPDUs. At this point, AP1 can overhear the TF sent by AP2 to STA21 and STA22, allowing it to identify an enhanced C-SR opportunity based on the information provided in the TF.

Furthermore, after overhearing the TF from AP2, LL data intended for STA11 arrives at AP1. AP1 can transmit this LL data without incurring a large delay by adjusting its transmit power. The adjusted transmit power can be calculated using the PSR_INPUT value indicated in the TF sent by AP2 and the Received Power Level (RPL) value, as described in the example given in FIG. 10.

By employing this expanded and enhanced C-SR mechanism in the C-TDMA scenario, AP1 can efficiently transmit LL data to its associated station (STA11) during AP2's TXOP, without causing significant delays or disruptions to the ongoing communications between AP2 and its associated stations (STA21 and STA22). This approach improves the overall performance and responsiveness of the wireless network in handling low latency traffic.

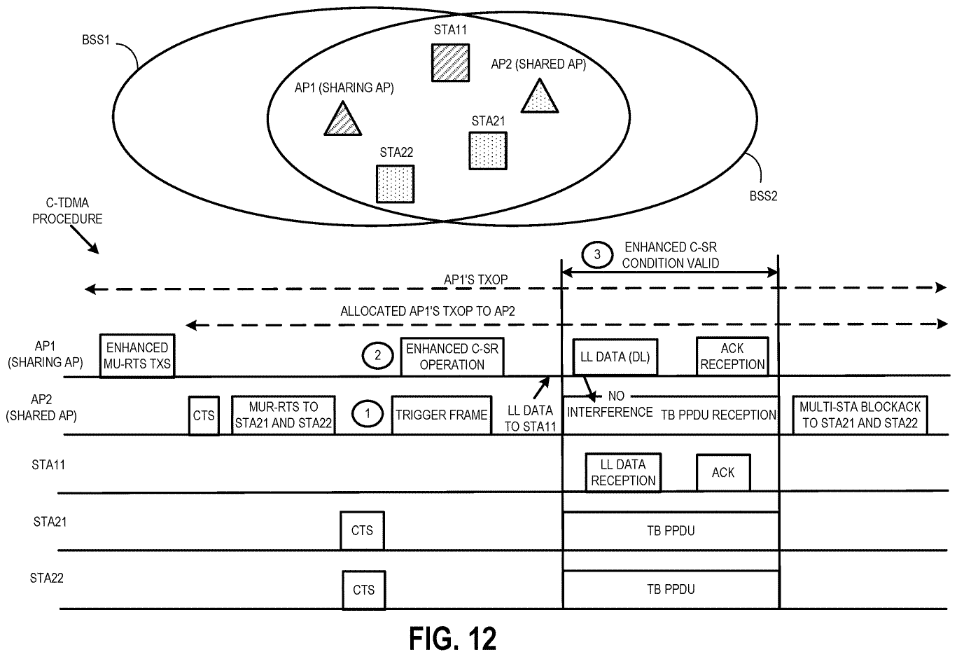

An expansion of the enhanced Coordinated Spatial Reuse (C-SR) scenario to include stations (STAs) associated with the sharing access point (AP), as illustrated by example in FIG. 12. In this scenario, it is assumed that the STAs associated with the sharing AP (AP1) may not set the basic Network Allocation Vector (NAV) when they overhear a Clear to Send (CTS) frame from the shared AP (AP2) in response to an enhanced Multi-User Request to Send Transmit Sequence (MU-RTS TXS) frame from the sharing AP.

Furthermore, it is assumed that STAs identifying an enhanced C-SR opportunity, such as when they overhear a Trigger Frame (TF) from AP2 (as shown by example in FIG. 11), may choose not to perform NAV update operations (e.g., NAV timer). Instead, these STAs can establish links to transmit low latency (LL) data using the Parameterized Spatial Reuse (PSR) mechanism. The steps for applying this mechanism to the STAs are similar to those depicted as a numbered circles in the example of FIG. 10.

FIG. 12 specifically illustrates an example of the enhanced C-SR operation in a Coordinated Time Division Multiple Access (C-TDMA) scenario when LL data occurs at STA11, which is associated with the sharing AP (AP1). In this case, STA11 can leverage the enhanced C-SR opportunity to transmit its LL data without significant delay, while still allowing the shared AP (AP2) to continue its communication with its associated STAs.

By extending the enhanced C-SR mechanism to include STAs associated with the sharing AP, the wireless network can further improve its efficiency and responsiveness in handling low latency traffic. This approach enables STAs to actively participate in the spatial reuse process, reducing delays and enhancing the overall performance of the network in C-TDMA scenarios.

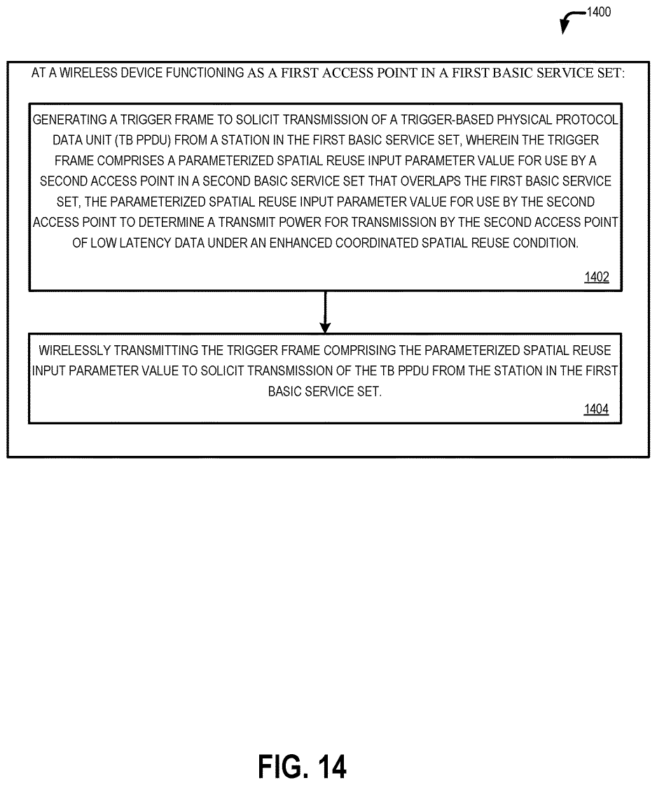

FIG. 14 is a flowchart of a method 1400 performed by a wireless device operating as a first access point (e.g., AP1 of FIG. 11) in a first basic service set (e.g., BSS1 of FIG. 11). The method aims to facilitate the transmission of low latency data by a second access point (e.g., AP2 of FIG. 11) in a second basic service set (e.g., BSS2 of FIG. 11) that overlaps with the first basic service set (e.g., BSS1 of FIG. 11), while minimizing interference between the two access points. For the purpose of providing a clear example, the steps of the method 1400 are explained below with parenthetical references to the example of FIG. 11. However, it should be noted that the method 1400 is not limited to the example of FIG. 11.

Step 1402: Generating a trigger frame

The first access point (e.g., AP1) generates a trigger frame to solicit the transmission of a trigger-based physical protocol data unit (TB PPDU) from a station (e.g., STA11) within its basic service set (BSS1). The trigger frame includes a parameterized spatial reuse input parameter value, which is intended for use by the second access point (e.g., AP2) in the second basic service set (e.g., BSS2). This parameter value will help the second access point determine the appropriate transmit power for transmitting low latency data under an enhanced coordinated spatial reuse condition.

The inclusion of the parameterized spatial reuse input parameter value in the trigger frame is useful, as it enables the second access point to transmit low latency data using constrained transmit power. This approach allows transmissions from both the station (e.g., STA11) in the first basic service set (e.g., BSS1) and the second access point (e.g., AP2) to coexist without causing harmful interference to one another, leading to increased spectral efficiency in scenarios where the two basic service sets overlap.

Step 1404: Wirelessly transmitting the trigger frame

After generating the trigger frame with the parameterized spatial reuse input parameter value, the first access point (e.g., AP1) wirelessly transmits the trigger frame to solicit the transmission of the TB PPDU from the station (e.g., STA11) in its basic service set (e.g., BSS1).

The transmission of the trigger frame serves at least two purposes:

It prompts the station (e.g., STA11) to send the TB PPDU, which is the primary objective of the trigger frame.

It conveys the parameterized spatial reuse input parameter value to the second access point (e.g., AP2), enabling it to determine the appropriate transmit power for sending low latency data under the enhanced coordinated spatial reuse condition.

The method 1400 enhances the coordination between access points in overlapping basic service sets by generating and transmitting a trigger frame containing a parameterized spatial reuse input parameter value. This parameter value allows the second access point (e.g., AP2) to efficiently transmit low latency data during shared time allocations using an enhanced C-SR technique with constrained transmit power, ultimately improving spectral efficiency and minimizing interference in the overlapping basic service sets.

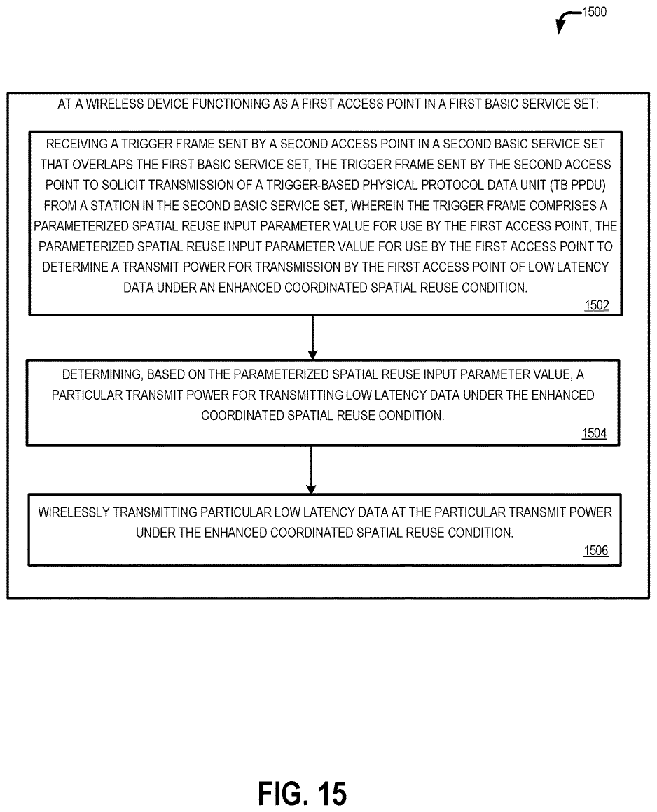

FIG. 15 illustrates a method 1500 performed by a wireless device operating as a first access point (e.g., AP2 of FIG. 11) in a first basic service set (e.g., BSS2 of FIG. 11). The method 1500 aims to enable the first access point (e.g., AP2) to transmit low latency data efficiently during shared time allocations by utilizing an enhanced Coordinated Spatial Reuse (C-SR) technique with constrained transmit power. For the purpose of providing a clear example, the steps of the method 1500 are explained below with parenthetical references to the example of FIG. 11. However, it should be noted that the method 1500 is not limited to the example of FIG. 11.

Step 1502: Receiving a trigger frame

The first access point (e.g., AP2) receives a trigger frame sent by a second access point (e.g., AP1) in a second basic service set (e.g., BSS1) that overlaps with the first basic service set (e.g., BSS2). The second access point (e.g., AP1) sends this trigger frame to solicit the transmission of a trigger-based physical protocol data unit (TB PPDU) from a station (e.g., STA11) within its basic service set (e.g., BSS1).

The received trigger frame includes a parameterized spatial reuse input parameter value intended for use by the first access point (e.g., AP2). This parameter value will help the first access point (e.g., AP2) determine the appropriate transmit power for transmitting low latency data under an enhanced coordinated spatial reuse condition.

Step 1504: Determining the particular transmit power

Upon receiving the trigger frame, the first access point (e.g., AP2) determines the particular transmit power for transmitting low latency data under the enhanced coordinated spatial reuse condition based on the parameterized spatial reuse input parameter value provided in the trigger frame.

The parameterized spatial reuse input parameter value enables the first access point (e.g., AP2) to calculate the optimal transmit power that allows it to send low latency data without causing significant interference to the station (e.g., STA11) in the second basic service set (e.g., BSS1).

Step 1506: Wirelessly transmitting low latency data

Having determined the appropriate transmit power, the first access point (e.g., AP2) wirelessly transmits the low latency data at the determined transmit power under the enhanced coordinated spatial reuse condition. This approach allows the first access point (e.g., AP2) to transmit low latency data using constrained transmit power through the enhanced C-SR technique.

By using the transmit power determined from the parameterized spatial reuse input parameter value, the first access point (e.g., AP2) supports transmission of low latency data that can coexist with ongoing communications in the second basic service set (e.g., BSS1) such as the TB PPDU (UL) transmission from the station (e.g., STA11) without causing harmful interference, resulting in increased spectral efficiency.

The method 1500 enables the first access point (e.g., AP2) to efficiently transmit low latency data by utilizing an enhanced C-SR technique with constrained transmit power. The method 1500 involves receiving a trigger frame containing a parameterized spatial reuse input parameter value from the second access point (e.g., AP1), determining the appropriate transmit power based on this value, and wirelessly transmitting the low latency data at the determined power level, ultimately minimizing interference and improving overall network performance.

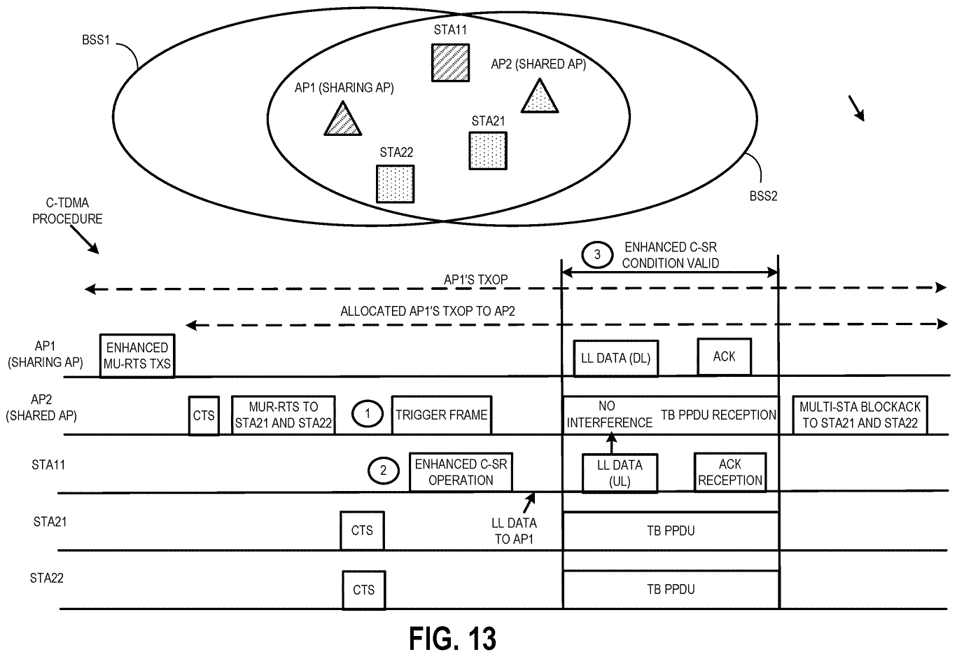

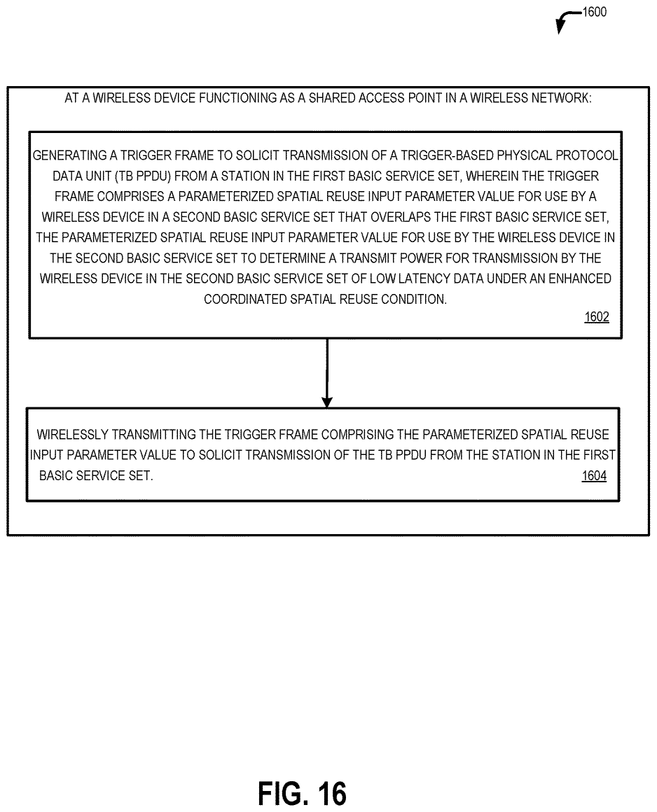

FIG. 16 illustrates a method 1600 performed by a wireless device operating as a shared access point (e.g., AP2 of FIG. 12 or FIG. 13) in a first basic service set (e.g., BSS2 of FIG. 12 or FIG. 13). The method 1600 aims to facilitate the transmission of low latency data by a wireless device (e.g., AP1 of FIG. 12 or STA11 of FIG. 13) in a second basic service set (e.g., BSS1 of FIG. 12 or FIG. 13) that overlaps with the first basic service set (e.g., BSS2 of FIG. 12 or FIG. 13), while minimizing interference between the two basic service sets. For the purpose of providing a clear example, the steps of the method 1600 are explained below with parenthetical references to the example of FIG. 12 or the example of FIG. 13. However, it should be noted that the method 1600 is not limited to the example of FIG. 12 or the example of FIG. 13.

Step 1602: Generating a trigger frame

The shared access point (e.g., AP2 of FIG. 12 or FIG. 13) generates a trigger frame to solicit the transmission of a trigger-based physical protocol data unit (TB PPDU) from a station (e.g., STA21 and/or STA22 of FIG. 12 or FIG. 13) within its basic service set (e.g., BSS2 of FIG. 12 or FIG. 13). The trigger frame includes a parameterized spatial reuse input parameter value, which is intended for use by a wireless device (e.g., AP1 of FIG. 12 or STA11 or FIG. 13) in the overlapping basic service set (e.g., BSS1 of FIG. 12 or FIG. 13).

The parameterized spatial reuse input parameter value will help the wireless device (e.g., AP1 of FIG. 12 or STA11 or FIG. 13) in the second basic service set (e.g., BSS1 of FIG. 12 or FIG. 13) determine the appropriate transmit power for transmitting low latency data under an enhanced coordinated spatial reuse condition. By including this value in the trigger frame, the shared access point (e.g., AP2 of FIG. 12 or FIG. 13) enables the wireless device (e.g., AP1 of FIG. 12 or STA11 or FIG. 13) in the second basic service set (e.g., BSS1 of FIG. 12 or FIG. 13) to transmit low latency data within the shared access point's (e.g., AP2's) allocated time using constrained transmit power through the enhanced Coordinated Spatial Reuse (C-SR) technique.

This approach allows transmissions from both the TB PPDU transmitting station(s) (e.g., STA21 and/or STA22 of FIG. 12 of FIG. 13) and the low latency data transmitting wireless device (e.g., AP1 of FIG. 12 or STA11 or FIG. 13) in the second basic service set (e.g., BSS1 of FIG. 12 or FIG. 13) to coexist without causing harmful interference to one another, resulting in increased spectral efficiency in scenarios where the two basic service sets overlap.

Step 1506: Wirelessly transmitting the trigger frame

After generating the trigger frame with the parameterized spatial reuse input parameter value, the shared access point (e.g., AP2 of FIG. 12 or FIG. 13) wirelessly transmits the trigger frame to solicit the transmission of the TB PPDU from the station(s) (e.g., STA21 and/or STA22 in FIG. 12 or FIG. 13) in its basic service set (e.g., BSS2 of FIG. 12 or FIG. 13).

The transmission of the trigger frame serves two purposes:

It prompts the station(s) (e.g., STA21 and/or STA22 of FIG. 12 or FIG. 13) to send the TB PPDU, which is the primary objective of the trigger frame.

It conveys the parameterized spatial reuse input parameter value to the wireless device (e.g., AP1 of FIG. 12 or STA11 of FIG. 13) in the second basic service set (e.g., BSS1 of FIG. 12 or FIG. 13), enabling it to determine the appropriate transmit power for sending low latency data under the enhanced coordinated spatial reuse condition.

The method 1600 enhances the coordination between the shared access point (e.g., AP2 of FIG. 12 or FIG. 13) and wireless devices (e.g., AP1 of FIG. 12 or STA11 of FIG. 13) in the overlapping basic service set (e.g., BSS1 of FIG. 12 or FIG. 13) by generating and transmitting a trigger frame containing a parameterized spatial reuse input parameter value. This parameter value allows the wireless device (e.g., AP1 of FIG. 12 or STA11 of FIG. 13) in the second basic service set (e.g., BSS1 of FIG. 12 or FIG. 13) to efficiently transmit low latency data during shared time allocations using an enhanced C-SR technique with constrained transmit power, ultimately improving spectral efficiency and minimizing interference between the basic service sets.

A wireless device of methods 1400, 1500, and 1600 can be an electronic device that can communicate with other devices or networks without the need for physical wires or cables. These devices use radio frequency (RF) waves to transmit and receive data over the air, enabling users to access information, communicate, and perform various tasks while maintaining mobility and flexibility. Wireless devices come in many forms, including smartphones, tablets, laptops, smartwatches, wireless headphones, and IoT (Internet of Things) devices such as smart home appliances and sensors. These devices are equipped with one or more antennas and radio transceivers that allow them to send and receive wireless signals. They also have processors, memory, and software that enable them to process data, run applications, and provide a user interface. Wireless devices can communicate using various wireless technologies and standards, such as Wi-Fi, Bluetooth, cellular networks (e.g., 4G, 5G), NFC (Near Field Communication), and RFID (Radio-Frequency Identification). These technologies differ in terms of their range, data transfer speeds, power consumption, and intended applications.

A Basic Service Set (BSS) of methods 1400, 1500, and 1600 may be fundamental building block of a wireless local area network (WLAN) as defined by the IEEE 802.11 standards. It encompasses a group of wireless devices, also known as stations (STAs), that communicate with each other within a specific coverage area. The BSS is managed by an access point (AP), which acts as a central hub for communication and coordination among the stations.

In a BSS, the access point may perform several functions. It may broadcast beacon frames periodically to announce the presence of the wireless network and its capabilities, such as supported data rates, security settings, and quality of service (QoS) parameters. The AP may also manage the association and authentication of stations that want to join the network, assigning them unique identifiers and allocating resources for their communication needs.

The stations in a BSS can communicate with each other through the access point, which acts as a relay for data traffic. When a station wants to send data to another station within the same BSS, it may first send the data to the AP, which may then forward it to the intended recipient. This communication mode is known as infrastructure mode, as opposed to ad-hoc mode, where stations communicate directly with each other without the need for an access point.

In the context of methods 1400, 1500, and 1600, multiple Basic Service Sets (e.g., BSS1 and BSS2) are mentioned, which can overlap in terms of their coverage areas. This scenario is common in dense wireless environments, such as office buildings or apartment complexes, where multiple access points are deployed to provide seamless connectivity to users. In such cases, coordination among the access points may be used to minimize interference and facilitate efficient utilization of the available wireless resources used techniques disclosed herein.

Basic service sets (BSSs) may overlap when their coverage areas intersect, allowing wireless devices in one BSS to detect and potentially interfere with transmissions from devices in the other BSS. There are several ways to determine if two BSSs overlap:

Signal strength measurement: Wireless devices in one BSS can measure the received signal strength indicator (RSSI) of transmissions from devices in another BSS. If the RSSI is above a certain threshold, it indicates that the two BSSs are close enough to overlap. Access points (APs) can use this information to make decisions about channel selection, transmit power control, and other network management functions.

Beacon frame detection: Each AP in a BSS periodically broadcasts beacon frames to announce its presence and provide information about the network. Wireless devices in one BSS can listen for beacon frames from APs in other BSSs. If a device detects beacon frames from multiple APs on the same or adjacent channels, it suggests that the BSSs overlap.

Client device feedback: Wireless clients, such as smartphones, tablets, or laptops, can provide feedback to the network about the presence of overlapping BSSs. For example, a client device may report that it can hear beacon frames or other transmissions from multiple APs simultaneously, indicating that the BSSs overlap.

In the context of method 1400, 1500, and 1600, the determination of overlapping BSSs may be performed for implementing enhanced coordinated spatial reuse (C-SR) techniques. By identifying which BSSs overlap, APs can exchange information and coordinate their transmissions to minimize interference and optimize the use of available spectrum resources. This coordination may be achieved through the use of trigger frames containing parameterized spatial reuse input parameter values, which help devices in overlapping BSSs determine the appropriate transmit power levels for sending low latency data.

A trigger frame of methods 1400, 1500, and 1600 may be a type of control frame introduced in the IEEE 802.11ax (Wi-Fi 6) standard to facilitate efficient multi-user communication in a wireless network. It may be sent by an access point (AP) to one or more stations (STAs) to solicit simultaneous uplink transmissions, enabling improved channel utilization and reduced overhead compared to traditional single-user communications.

The trigger frame may contain information used by the stations to participate in the upcoming multi-user uplink transmission. This information may include the resource allocation for each station, such as the specific subcarriers and time slots assigned to them in the uplink multi-user transmission. The trigger frame may also specify the type of data expected from each station, such as a trigger-based physical protocol data unit (TB PPDU) or a quality of service (QoS) data frame.

Upon receiving the trigger frame, the stations may prepare their data according to the specified requirements and wait for the assigned time slot to begin their uplink transmission. The AP may then simultaneously receive the uplink transmissions from multiple stations, which can significantly increase the overall throughput and efficiency of the wireless network.

In the context of the methods 1400, 1500, and 1600, the trigger frame may serve an additional purpose beyond facilitating multi-user uplink transmissions. It may also include a parameterized spatial reuse input parameter value, which is intended for use by a wireless device (e.g., an AP or STA) in a neighboring or overlapping basic service set (BSS). This parameter value may help the wireless device determine the appropriate transmit power for sending low latency data under an enhanced coordinated spatial reuse (C-SR) condition, allowing concurrent transmissions in overlapping BSSs while minimizing interference.

By including the parameterized spatial reuse input parameter value in the trigger frame, the AP may enable the wireless device in the neighboring BSS to transmit low latency data within the shared AP's allocated time using constrained transmit power. This approach may promote efficient spatial reuse and may enhance overall network performance in dense wireless environments where multiple BSSs coexist.

A TB PPDU, or trigger-based physical protocol data unit, of methods 1400, 1500, and 1600 may be a type of data unit transmitted by a station (STA) in response to a trigger frame sent by an access point (AP) in a wireless local area network (WLAN) that supports the IEEE 802.11ax (Wi-Fi 6) standard or later. The TB PPDU may be a component of the multi-user uplink transmission mechanism introduced in Wi-Fi 6 to improve network efficiency and throughput.

When an AP wants to initiate a multi-user uplink transmission, it may send a trigger frame to one or more STAs, specifying the resources allocated for each STA to transmit its data. The trigger frame may include information such as the assigned time slots, frequency subcarriers, and spatial streams for each STA. Upon receiving the trigger frame, the STAs may prepare their data in the form of TB PPDUs, which may be designed to fit within the allocated resources.

A TB PPDU may encompass a preamble and a data field. The preamble may contain information for the AP to detect, synchronize, and decode the incoming transmission, such as the modulation and coding scheme (MCS) and the spatial stream configuration. The data field may carry the actual payload, which can be a MAC protocol data unit (MPDU) or an aggregate MPDU (A-MPDU).

The TB PPDU may be transmitted by the STA in its assigned time slot and frequency resources, as specified in the trigger frame. The AP may then simultaneously receive TB PPDUs from multiple STAs, enabling efficient multi-user uplink communication. This approach may reduce the overhead associated with individual STA transmissions and may allow for better utilization of the available channel resources.

In the context of methods 1400, 1500, and 1600, the TB PPDU may be the expected response from the STAs to the trigger frame sent by the AP. The trigger frame may solicit the transmission of TB PPDUs from the STAs within the same basic service set (BSS) as the AP. Additionally, the trigger frame may include a parameterized spatial reuse input parameter value, which is intended for use by a wireless device (e.g., an AP or STA) in a neighboring or overlapping BSS to determine the appropriate transmit power for sending low latency data under an enhanced coordinated spatial reuse (C-SR) condition.

Low latency data in methods 1400, 1500, and 1600 may encompass data traffic that requires minimal delay between the time it is sent and the time it is received. In the context of wireless networks, low latency data may be important for applications and services that are sensitive to delays, such as real-time voice and video communication, online gaming, virtual reality, and industrial control systems.

In these applications, even small delays in data transmission can lead to noticeable quality degradation, reduced user experience, or impaired functionality. For example, in a voice call, high latency can cause stuttering, echoes, or dropped words, making the conversation difficult to understand. Similarly, in online gaming, high latency can result in lag, leading to a competitive disadvantage and frustration for players.

To support low latency data transmission in wireless networks, various techniques and technologies have been developed. These include optimized medium access control (MAC) protocols, quality of service (QoS) mechanisms, and advanced physical layer (PHY) techniques such as orthogonal frequency division multiple access (OFDMA) and multi-user multiple-input multiple-output (MU-MIMO).

In the context of the method 1400, 1500, and 1600, low latency data transmission may be a concern in scenarios where multiple basic service sets (BSSs) overlap. When an access point (AP) in one BSS is transmitting low latency data, it may be useful to minimize interference from neighboring BSSs to facilitate delivery of the data with minimal delay.

To address this issue, the methods 1400, 1500, and 1600 encompass an AP that may include a parameterized spatial reuse input parameter value in its trigger frame. This parameter value may be intended for use by a wireless device (e.g., an AP or station) in a neighboring BSS to determine the appropriate transmit power for sending its own low latency data under an enhanced coordinated spatial reuse (C-SR) condition. By coordinating the transmit power levels and timing of low latency data transmissions across overlapping BSSs, the network can minimize interference and may facilitate delivery of the low latency data with the required quality of service.

The present disclosure proposes enhanced Coordinated Spatial Reuse (C-SR) mechanisms to improve spectrum utilization in a Coordinated Time Division Multiple Access (C-TDMA) scenario. In a typical C-TDMA scenario, the sharing access point (AP) is not allowed to transmit or receive frames during the time allocated to the shared AP, known as the shared AP's service time. This limitation can lead to significant delays when low latency (LL) data occurs at the sharing AP's side, as the LL traffic cannot be transmitted immediately.

To address this issue, the present disclosure discloses a method that enables the sharing AP to transmit LL traffic without incurring large delays, even during the shared AP's service time. By employing the enhanced C-SR mechanisms, the sharing AP can efficiently utilize the available spectrum resources to transmit LL data, improving the overall performance and responsiveness of the wireless network.

Furthermore, the disclosed method reduces the probability of collisions and minimizes interference during the shared AP's Transmit Opportunity (TXOP) duration. By coordinating the spatial reuse of the spectrum, the enhanced C-SR mechanisms facilitates the sharing AP's LL traffic coexisting with the ongoing transmissions of the shared AP and its associated stations, without causing significant disruptions or interference.

The present discloses introduces enhanced C-SR mechanisms that optimize spectrum utilization in C-TDMA scenarios, enabling the sharing AP to transmit LL traffic without significant delays and reducing the likelihood of collisions and interference during the shared AP's allocated service time. These improvements contribute to a more efficient and responsive wireless network, particularly in situations where low latency traffic is useful.

### Other Considerations

The solutions presented in this document have been described in the context of a wireless LAN system. However, it is important to note that these solutions are not limited to wireless LANs and can be applied to other network environments, such as cellular telecommunication networks and wired networks.

An embodiment of the present disclosure may take the form of an article of manufacture, where a non-transitory machine-readable medium, such as microelectronic memory, stores instructions that program one or more data processing components, referred to as a “processor” or “processing unit,” to perform the operations described earlier. In other embodiments, some of these operations might be carried out by specific hardware components containing hardwired logic, such as dedicated digital filter blocks and state machines. Alternatively, these operations could be performed by a combination of programmed data processing components and fixed hardwired circuit components.

In some cases, an embodiment of the invention may be an apparatus, such as an access point station (AP STA), a non-AP station (non-AP STA), or another network or computing device, that includes one or more hardware and software logic structures for performing one or more of the described operations. For example, as previously mentioned, the apparatus may include a memory unit that stores instructions executable by a hardware processor installed in the apparatus. The apparatus may also incorporate additional hardware or software elements, such as a network interface or a display device.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art.

An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method performed by a wireless device operating as a first access point in a first basic service set, the method comprising:
generating a trigger frame to solicit transmission of a trigger-based physical protocol data unit (TB PPDU) from a station in the first basic service set, wherein the trigger frame comprises a parameterized spatial reuse input parameter value for use by a second access point in a second basic service set that overlaps the first basic service set, the parameterized spatial reuse input parameter value for use by the second access point to determine a transmit power for transmission by the second access point of low latency data under an enhanced coordinated spatial reuse condition; and
wirelessly transmitting the trigger frame comprising the parameterized spatial reuse input parameter value to solicit transmission of the TB PPDU from the station in the first basic service set.

2. The method of claim 1, further comprising:
determining the parameterized spatial reuse input parameter value based on both: (a) an estimated total power at an antenna connector to be used by the first access point to transmit the trigger frame, and (b) a maximum interference level that can be detected at the first access point.

3. The method of claim 1, wherein the second access point transmits low latency data under the enhanced coordinated spatial reuse condition and the station in the first basic service set transmits the trigger-based physical protocol data unit (TB PPDU).

4. The method of claim 1, wherein the second access point transmits low latency data under the enhanced coordinated spatial reuse condition to a station in the second basic service set.

5. A method performed by a wireless device operating as a first access point in a first basic service set, the method comprising:
receiving a trigger frame sent by a second access point in a second basic service set that overlaps the first basic service set, the trigger frame sent by the second access point to solicit transmission of a trigger-based physical protocol data unit (TB PPDU) from a station in the second basic service set, wherein the trigger frame comprises a parameterized spatial reuse input parameter value for use by the first access point, the parameterized spatial reuse input parameter value for use by the first access point to determine a transmit power for transmission by the first access point of low latency data under an enhanced coordinated spatial reuse condition;
determining, based on the parameterized spatial reuse input parameter value, a particular transmit power for transmitting low latency data under the enhanced coordinated spatial reuse condition; and
wirelessly transmitting particular low latency data at the particular transmit power under the enhanced coordinated spatial reuse condition.

6. The method of claim 5, further comprising:
determining the particular transmit power based on both: (a) an intended transmission bandwidth and (b) a received power level indicating the receiving power of the trigger frame.

7. The method of claim 5, wherein the particular low latency data is transmitted to a station in the first basic service set.

8. A method performed by a wireless device operating as a shared access point in a first basic service set, the method comprising:
generating a trigger frame to solicit transmission of a trigger-based physical protocol data unit (TB PPDU) from a station in the first basic service set, wherein the trigger frame comprises a parameterized spatial reuse input parameter value for use by a wireless device in a second basic service set that overlaps the first basic service set, the parameterized spatial reuse input parameter value for use by the wireless device in the second basic service set to determine a transmit power for transmission by the wireless device in the second basic service set of low latency data under an enhanced coordinated spatial reuse condition; and
wirelessly transmitting the trigger frame comprising the parameterized spatial reuse input parameter value to solicit transmission of the TB PPDU from the station in the first basic service set.

9. The method of claim 8, further comprising:
determining the parameterized spatial reuse input parameter value based on both: (a) an estimated total power at an antenna connector to be used by the shared access point to transmit the trigger frame, and (b) a maximum interference level that can be detected at the shared access point.

10. The method of claim 8, wherein the wireless device in the second basic service set operates as a sharing access point in the second basic service set; and wherein the sharing access point in the second basic service set transmits low latency data under the enhanced coordinated spatial reuse condition to a station in the second basic service set.

11. The method of claim 8, wherein the wireless device in the second basic service set operates as a station in the second basic service set; and wherein the station in the second basic service set transmits low latency data under the enhanced coordinated spatial reuse condition to a sharing access point in the second basic service set.

12. A wireless device capable of functioning as a first access point in a first basic service set, the wireless device comprising:
a radio frequency transceiver;
a memory device storing a set of instructions; and
a set of one or more processors coupled to the memory device, wherein the set of instructions are configured to cause the first access point to perform:
generating a trigger frame to solicit transmission of a trigger-based physical protocol data unit (TB PPDU) from a station in the first basic service set, wherein the trigger frame comprises a parameterized spatial reuse input parameter value for use by a second access point in a second basic service set that overlaps the first basic service set, the parameterized spatial reuse input parameter value for use by the second access point to determine a transmit power for transmission by the second access point of low latency data under an enhanced coordinated spatial reuse condition; and
wirelessly transmitting the trigger frame comprising the parameterized spatial reuse input parameter value to solicit transmission of the TB PPDU from the station in the first basic service set.

13. The wireless device of claim 12, further comprising a set of instructions stored in the memory device and configured to cause the first access point to perform:
determining the parameterized spatial reuse input parameter value based on both: (a) an estimated total power at an antenna connector to be used by the first access point to transmit the trigger frame, and (b) a maximum interference level that can be detected at the first access point.

14. The wireless device of claim 12, wherein the second access point is configured to transmit low latency data under the enhanced coordinated spatial reuse condition and the station in the first basic service set is configured to transmit the trigger-based physical protocol data unit (TB PPDU).

15. The wireless device of claim 12, wherein the second access point is configured to transmit low latency data under the enhanced coordinated spatial reuse condition to a station in the second basic service set.

16. A wireless device capable of functioning as a first access point in a first basic service set, the wireless device comprising:
a radio frequency transceiver;
a memory device;
a set of one or more processors coupled to the memory device; and
a set of instructions stored in the memory device and configured to cause the first access point to perform:
receiving a trigger frame sent by a second access point in a second basic service set that overlaps the first basic service set, the trigger frame sent by the second access point to solicit transmission of a trigger-based physical protocol data unit (TB PPDU) from a station in the second basic service set, wherein the trigger frame comprises a parameterized spatial reuse input parameter value for use by the first access point, the parameterized spatial reuse input parameter value for use by the first access point to determine a transmit power for transmission by the first access point of low latency data under an enhanced coordinated spatial reuse condition;
determining, based on the parameterized spatial reuse input parameter value, a particular transmit power for transmitting low latency data under the enhanced coordinated spatial reuse condition; and
wirelessly transmitting particular low latency data at the particular transmit power under the enhanced coordinated spatial reuse condition.

17. The wireless device of claim 16, further comprising a set of instructions stored in the memory device and configured to cause the first access point to perform:
determining the particular transmit power based on both: (a) an intended transmission bandwidth and (b) a received power level indicating the receiving power of the trigger frame.

18. The wireless device of claim 16, wherein the first access point is configured to wirelessly transmit the particular low latency data to a station in the first basic service set.

19. A wireless device capable of functioning as a shared access point in a first basic service set, the wireless device comprising:
a radio frequency transceiver;
a memory device;
a set of one or more processors coupled to the memory device; and
a set of instructions stored in the memory device and configured to cause the shared access point to perform:
generating a trigger frame to solicit transmission of a trigger-based physical protocol data unit (TB PPDU) from a station in the first basic service set, wherein the trigger frame comprises a parameterized spatial reuse input parameter value for use by a wireless device in a second basic service set that overlaps the first basic service set, the parameterized spatial reuse input parameter value for use by the wireless device in the second basic service set to determine a transmit power for transmission by the wireless device in the second basic service set of low latency data under an enhanced coordinated spatial reuse condition; and
wirelessly transmitting the trigger frame comprising the parameterized spatial reuse input parameter value to solicit transmission of the TB PPDU from the station in the first basic service set.

20. The wireless device of claim 19, further comprising a set of instructions stored in the memory device and configured to cause the shared access point to perform:
determining the parameterized spatial reuse input parameter value based on both: (a) an estimated total power at an antenna connector to be used by the shared access point to transmit the trigger frame, and (b) a maximum interference level that can be detected at the shared access point.

21. The wireless device of claim 19, wherein the wireless device in the second basic service set is configured to operate as a sharing access point in the second basic service set;
and wherein the sharing access point in the second basic service set is configured to transmit low latency data under the enhanced coordinated spatial reuse condition to a station in the second basic service set.

22. The wireless device of claim 19, wherein the wireless device in the second basic service set is configured to operate as a station in the second basic service set; and wherein the station in the second basic service set is configured to transmit low latency data under the enhanced coordinated spatial reuse condition to a sharing access point in the second basic service set.
